(19) United States
(12) Patent Application Publication
(10) Pub. No.: US 2007/0012406 A1
(43) Pub. Date: Jan. 18, 2007

(54) TAPE DISPENSING DEVICE

(76) Inventor: Sneha Kakade, Ft. Dodge, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/160,834

(22) Filed: Jul. 12, 2005

(51) Int. Cl. B44C 7/00

(52) U.S. Cl. 156/577

(57) ABSTRACT

A tape dispensing device having a block with a cutting edge. Extending from the block are side members. A retaining bar is moveably connected to and extends between the side members such that the block, side members and retaining bar define an opening. A roll of tape is disposed through the opening and as the roll of tape decreases in size, the retaining member is moved along the side members to retain the roll of tape within the opening.

### BACKGROUND OF THE INVENTION

This application relates to a tape dispensing device. More specifically, this application relates to a tape dispensing device that is easy to store and transport.

Typically, a tape dispensing device has a plastic or metal housing that receives a roll of tape. Mounted on the housing is a cutting edge for tearing the tape. While effective, these devices are cumbersome requiring room for storage particularly when transported in a tool box, purse, or the like. Accordingly, a need exists for a tape dispensing device that addresses this problem.

Therefore, a primary object of the present invention to provide a tape dispensing device that is easy to transport.

Another object of the present invention is to provide a tape dispensing device that requires little room for storage.

These and other objects, features, and advantages will be disclosed within the rest of specification and the claims.

### BRIEF SUMMARY OF THE INVENTION

A tape dispensing device having a block with a cutting edge. Extending from the block are a pair of side members. A retaining bar is moveably connected to and extends between the side members such that the retaining bar is movable toward the block. The block side members and retaining bar define an opening that receive a roll of tape. As the roll of tape decreases in size the retaining bar is moved toward the block to securely hold the roll of tape as the roll becomes smaller.

### BRIEF DESCRIPTION OF THE DRAWINGS

FIG. 1 is a perspective view of a tape dispensing device;

FIG. 2 is a side view of a tape dispensing device; and

FIG. 3 is an alternative embodiment of a tape dispensing device.

### DETAILED DESCRIPTION OF THE PREFERRED EMBODIMENT

Referring to the Figures, a tape dispensing device has a block or plate 12 with cutting edge or blade 14 at one corner of the plate 12. The cutting edge 14 is formed as part of the plate 12, or alternatively is connected to the plate.

Connected to the plate 12 end extending generally perpendicularly to the plate 12, are a pair of side members 16 and 18. In one embodiment, the side members 16, 18, have a plurality of triangular flanges 20. Movably connected and extending between the side members 16, 18 is a retaining bar 22. The retaining bar 22 is of various types such as a wire, plastic bar, or the like.

Mounted about the retaining bar 22, and received with an opening 24 formed between the plate 12, side members 16, 18, and bar 22, is a roll of tape 26. The roll of tape is of any type including duct and electrical tape. A strand 28 of tape is extended from the roll 26 to the plate 12 where the strand 28 is cut or torn against edge 14 as pressure is applied.

In operation, the roll 26 is mounted on the retaining bar 22. Manual pressure is applied to the roll 26 and the bar 22 to move the bar 22 along the side members 16, 18 such that the bar 22 rides over the angular portion of flange 20 locking the retaining bar 22 in position as it engages the perpendicular portion of flange 20. In this manner, as the roll 26 of tape decreases in size, the bar 22 is moved toward plate 12 to snuggly retain the roll 26 within opening 24.

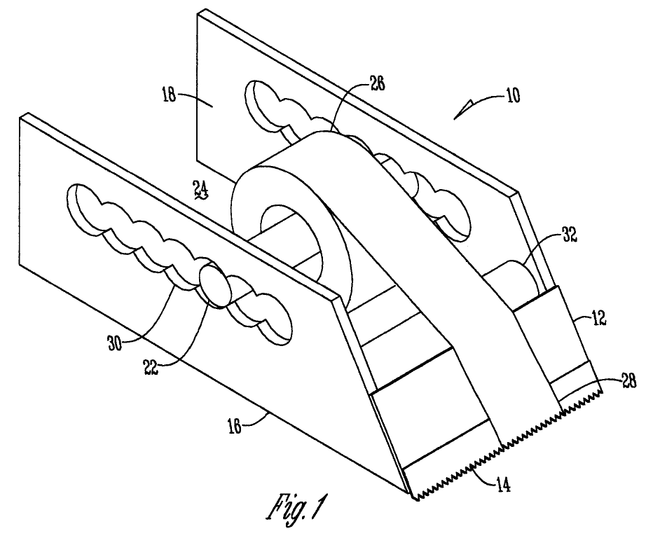

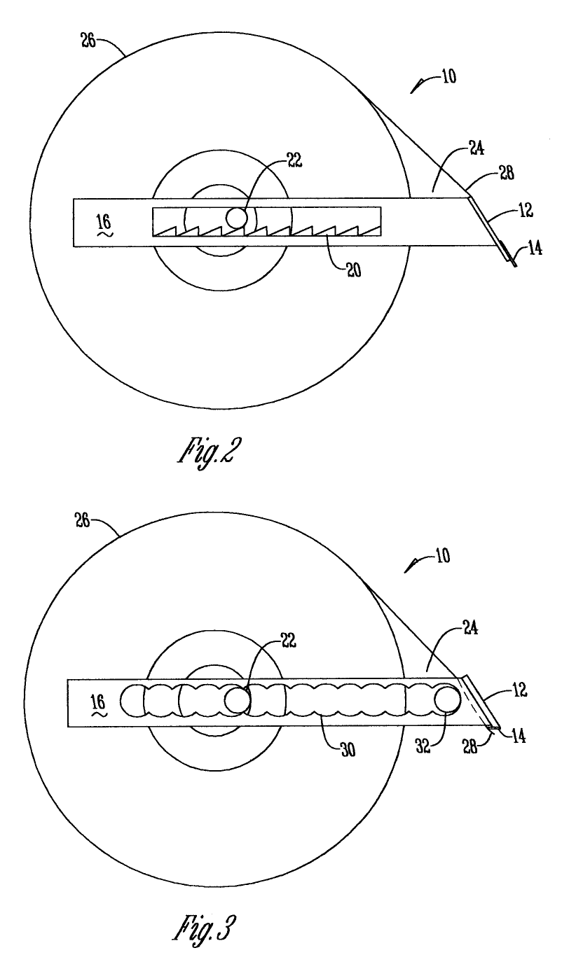

Alternatively, the side members 16, 18 have a plurality of slots 30 in spaced alignment. Additionally, the retaining bar 22 is comprised of a roller that is frictionally and rotatably received within the slots 30. In similar manner, pressure is applied to the roll 26 and/or bar 22 to move the bar 22 within the slots 30 on the side members 16, 18 toward the plate. To further facilitate dispensing of tape from the roll, a second roller 32 is connected to the side members 16, 18 adjacent the plate. The second roller is stationary as shown in FIG. 1, or movably received in slots 30 as shown in FIG. 3.

It will be appreciated by those skilled in the art that other various modifications could be made to the device without the parting from the spirit in scope of this invention. All such modifications and changes fall within the scope of the claims and are intended to be covered thereby.

What is claimed is:

1. A tape dispensing device comprising:
a block having a cutting edge;
side members extending from the block;
a retaining bar moveably connected to and extending between the side members.

2. The tape dispensing device of claim 1 wherein the block, the side members, and retaining bar define an opening, and a roll of tape is mounted to the retaining bar and extends through the opening.

3. The tape dispensing device of claim 1 wherein the retaining bar is a wire.

4. The tape dispensing device of claim 1 wherein the retaining bar is a roller.

5. The tape dispensing device of claim 1 wherein the retaining bar is made of plastic.

6. The tape dispensing device of claim 1 wherein the side members have a plurality of flanges.

7. The tape dispensing device of claim 1 wherein side members have a plurality of slots.

8. The tape dispensing device of claim 1 further comprising a roller connected to and extending between the side members.
